(19) United States
(12) Patent Application Publication
(10) Pub. No.: US 2015/0234104 A1
(43) Pub. Date: Aug. 20, 2015

(54) Transparent Composite Including a Solar Control Layer and a Method of Forming the Same

(71) Applicant: Saint-Gobain Performance Plastics Corporation, Aurora, OH (US)

(72) Inventor: Fabien Lienhart, San Diego, CA (US)

(21) Appl. No.: 14/623,324

(22) Filed: Feb. 16, 2015

Related U.S. Application Data
(60) Provisional application No. 61/940,728, filed on Feb. 17, 2014.

(51) Int. Cl. G02B 5/20

(52) U.S. Cl. CPC G02B 5/208; Y02B 80/20

(57) ABSTRACT

A transparent composite can include a textured substrate and a solar control layer. Portions of the solar control layer may lie at different elevations that are separated by a sidewall of the textured substrate. The portions may be electrically disconnected from each other or include other portions that are highly resistive. In an embodiment, the solar control layer can be non-conformally deposited over the textured substrate. The solar control layer can be formed such that there are no lateral gaps between portions of the solar control layer. In a particular embodiment, the transparent composite can have good transmission of visible light and high frequency signals while still achieving suitably low transmission of near infrared radiation.

### CROSS-REFERENCE TO RELATED APPLICATION

The present application claims priority under 35 U.S.C. §119(e) to U.S. Provisional Patent Application No. 61/940,728, filed Feb. 17, 2014, entitled “A Transparent Composite Including a Solar Control Layer and a Method of Forming the Same”, naming as an inventor Fabien Lienhart, which is incorporated by reference herein in its entirety.

### FIELD OF THE DISCLOSURE

The present disclosure is directed to transparent composites including a solar control layer and methods of forming the same.

### BACKGROUND

More governments are mandating and consumers are requiring that windows reduce heat transmission from the sun into the inside of buildings or vehicles. Most of the heat is transmitted as near infrared radiation having wavelengths in a range of 800 nm to 2500 nm. Solar control layers have been used for many years and are effective to reduce the transmission of near infrared radiation while allowing acceptable transmission of visible light having wavelengths in a range of 400 nm to 700 nm.

Cellular phones, smartphone, tablet computers, and the like typically wirelessly communicate with cellular towers or other infrastructure equipment at frequencies typically in a range of 0.8 GHz to 2.5 GHz and even higher frequencies. Users of such phones, computers, and other cellular equipment need to be able to have their devices wirelessly communicate through windows of buildings and vehicles. Wireless transmission through a sheet of glass or plastic can be performed with no significant signal loss. While solar control layers significantly reduce near infrared transmission without significantly reducing visible light, such solar control layers can significantly attenuate the transmission of electromagnetic radiation used for wireless communications. Many attempts to address the problem allow too much of the near infrared radiation to pass or have complicated fabrication schemes.

### BRIEF DESCRIPTION OF THE DRAWINGS

Embodiments are illustrated by way of example and are not limited in the accompanying figures.

FIG. 1 includes a plot of transmission of a signal at 1.8 GHz as a function of sheet resistance.

FIG. 2 includes an illustration of a cross-sectional view of a portion of a textured substrate and a solar control layer in accordance with an embodiment.

FIG. 3 includes a circuit model of the solar control layer of FIG. 2.

FIG. 4 includes an illustration of a cross-sectional view of a portion of a textured substrate and a solar control layer in accordance with an embodiment.

FIG. 5 includes a circuit model of the solar control layer of FIG. 4.

FIGS. 6 and 7 include illustrations of a cross-sectional view and a perspective view, respectively, of a portion of a workpiece including a support substrate and a textured substrate in accordance with an embodiment.

FIG. 8 includes an illustration of a perspective view of a portion of a workpiece including a support substrate and a textured substrate in accordance with an alternative embodiment.

FIG. 9 includes an illustration of a top view of a portion of a workpiece including a textured substrate in accordance with another alternative embodiment.

FIGS. 10 and 11 include illustrations of a cross-sectional view and a perspective view, respectively, of the workpiece of FIGS. 6 and 7 after forming a solar control layer in accordance with an embodiment.

FIG. 12 includes an illustration of a cross-section view of the workpiece of FIGS. 10 and 11 after filling remaining portions of trenches with a trench-fill material in accordance with an embodiment.

FIG. 13 includes a cross-sectional view of a substantially completed transparent composite in accordance with an embodiment.

FIG. 14 includes an illustration of a cross-sectional view of a portion of a workpiece including the support substrate and a textured substrate in accordance with an alternative embodiment.

FIG. 15 includes an illustration of a cross-sectional view of a portion of a workpiece including the support substrate, a body layer, a capping layer, and a masking layer after etching portions of the body and capping layers in accordance with an alternative embodiment.

FIG. 16 includes an illustration of a cross-sectional view of the workpiece of FIG. 15 after selectively widening the portions of the trenches within the body layer in accordance with an alternative embodiment.

FIGS. 17 and 18 include scanning electron microscope images of a textured substrate and a metal layer deposited over the textured substrate.

FIG. 19 includes an illustration of a system setup for testing transmission attenuation of a radio-frequency signal though a sample (device under test).

FIG. 20 includes a graph illustrating transmission attenuation (signal loss) as a function of sheet resistance.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

The term “effective sheet resistance” is intended to mean a sheet resistance of a material or layer as adjusted for a pattern. For example, a layer when formed over a flat surface may have a sheet resistance of 200 ohms/square. After patterning, the width of the layer (measured in a direction orthogonal to the thickness) may only be 10% of the width of the layer as originally formed. The effective sheet resistance is the sheet resistance (200 ohms/square) times the fraction of the width of the layer remaining after patterning (0.1), which is 2000 ohms/square for this example.

As used herein, the visible light transmittance (VLT) in intended to mean the ratio of total visible light that is transmitted through a window film/glass system to the total visible light that reaches the window film/glass system.

The visible light reflectance (VLR) is intended to mean the total visible light that is reflected by a window film/glass system to the total visible light that reaches the window film/glass system.

The total solar energy rejected (TSER) is intended to mean the total solar energy (heat) rejected by a window film/glass system.

The Solar Heat Gain Coefficient (SHGC) in intended to mean the total solar energy (for example, heat transmitted through a window film/glass system), as measured using the equation: SHGC=1−TSER.

The selectivity(ies) or Light To Solar Heat Gain Coefficient (LTSHGC) is intended to mean the ratio of the VLT divided by the SHGC, as measured using the following equation: s=LTSHGC=VLT/SHGC.

The VLT, VLR, TSER, SHGC and LTSHGC are calculated according to the ASTM standard (see e.g., NFRC-100, NFRC-200 and NFRC-300).

The performance values provided in this specification are meant to correspond to the values measured when applying a transparent composite film to a 3 mm (⅛ inch) clear glass sheet or when fabricating a transparent composite from the 3 mm (⅛ inch) clear glass sheet.

As used herein, attenuation is the loss of intensity of electromagnetic radiation for the electromagnetic radiation passing through a medium, such as a window film/glass system. Attenuation may be expressed as the actual value (e.g., −5 dB) or as an absolute value (e.g., 5 dB) for the same amount of attenuation.

The terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the solar control and window arts.

A transparent composite can include a textured substrate and a solar control layer. Portions of the solar control layer can be formed at different elevations separated from each other by a sidewall. In an embodiment, trenches within the textured substrate can be present when the textured substrate is formed, or the trenches may be formed within a layer, or may be formed by depositing a material over a layer. The elevational difference between the bottom of the trench and the surface outside the trench can allow the solar control layer to have discrete, spaced-apart portions within and outside the trench. In an embodiment, the solar control layer can be non-conformally deposited over the textured substrate. The solar control layer does not need to be crushed, fractured, or have portions laser ablated or otherwise removed to form the discrete, spaced apart portions. In a direction normal to the major surfaces of the transparent composite, the solar control layer does not have any lateral gaps, and therefore, transmission of near infrared radiation is significantly reduced as compared to conventional window films where the solar control layer includes broken into pieces after the solar control layer is formed. A conventional solar control layer with nanoparticles can either (1) have enough nanoparticles to provide good near infrared (IR) performance but have poor visible light transmission, or (2) have good visible light transmission but allow too much near IR radiation to be transmitted. Furthermore, the transparent composite may be formed with only one solar control layer. Thus, multiple solar control layers do not need to be deposited and patterned. The transparent composite can be fabricated so that haze is low. Haze can be measured using a Haze-Gard™-brand haze meter instrument from BYK Gardner. In a particular embodiment, haze can be measured in accordance with ASTM D 1003.

Before addressing particular embodiments, issues related to attenuation of high frequency signals by solar control layers are addressed. Some materials, such as Ag, Au, Cu, Al, or a transparent conducting oxide (TCO) in general, such as Indium Tin Oxide (ITO), Al or Ga doped Zinc Oxide (ZnO), used in solar control layers are highly conductive. FIG. 1 includes a plot of transmission of electromagnetic radiation at a frequency of 1.8 GHz through a layer as a function of sheet resistance of the layer. As can be seen with the plot, signal attenuation is significant as the sheet resistance decreases. In particular, transmission is −46 dB at 1 ohm/square (noted as Ω□ in figures), −27 dB at 10 ohms/square, and −10 dB at 100 ohms/square. Thus, too low of a sheet resistance does not allow sufficient transmission of electromagnetic radiation for wireless communications. However, transmission is between 0 dB and −1 dB at 10,000 ohms/square and higher.

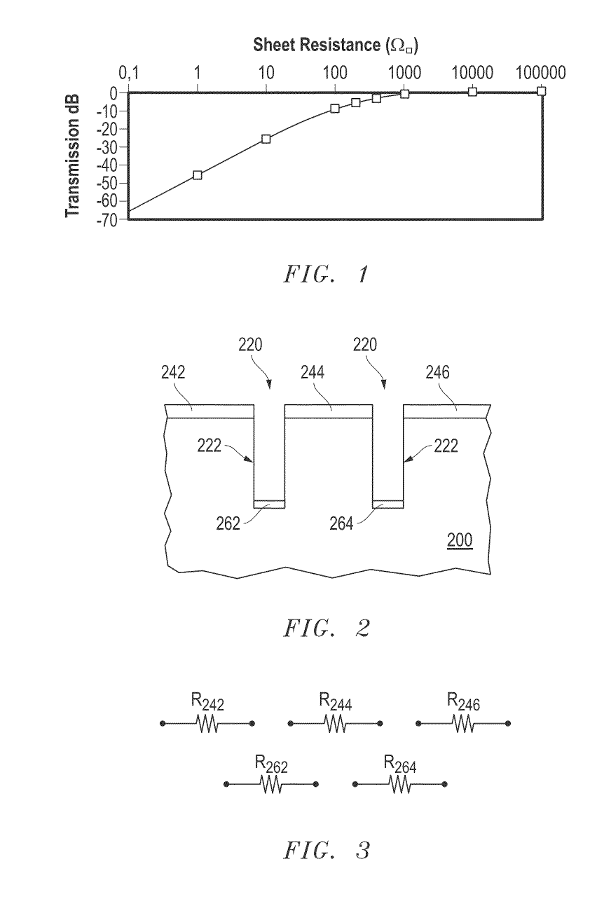

Exemplary embodiments are described below that illustrate and do not limit the scope of the appended claims. FIG. 2 includes of an illustration of a cross-sectional view of a portion of a textured substrate 200 and portions of a solar control layer. The solar control layer significantly reduces transmission of near IR radiation and still allows sufficient transmission of visible light. In the embodiment of FIG. 2, the textured substrate 200 has trenches 220 have substantially vertical sidewalls 222. Portions 242, 244, and 246 of the solar control layer are disposed over the top surfaces of the textured substrate 200 outside of the trenches 220. Portions 262 and 264 of the solar control layer are disposed over the bottom surfaces of the trenches 220. The portions 242, 244, and 246 are separated from the portions 262 and 264 by the sidewalls 222 of the trenches.

When the embodiment of FIG. 2 is electrically modeled, each of the portions can have corresponding resistances R₂₄₂, R₂₄₄, R₂₄₆, R₂₆₂, and R₂₆₄ as illustrated in FIG. 3. Because the portions 242, 244, 246, 262, and 264 of the solar control layer are spaced apart, such portions are represented as resistors that are not electrically connected to each other, and thus, is an open circuit. If a voltage difference were to be applied across the solar control layer between the portions 242 and 246, no current would flow. Referring to FIG. 1, such a situation results in a very high sheet resistance (significantly greater than 100,000 ohms/square) and has no significant attenuation of signals for wireless communications.

In another embodiment, the textured substrate can be in the form of mesas and an interconnected trench between the mesas. In this embodiment, the resistors R₂₆₂ and R₂₆₄ are connected. The widths of the trenches can be adjusted to achieve a desired effective sheet resistance for the portion of the solar control layer within the trenches. For example, a higher effective sheet resistance is needed or desired, the trench can be narrower. The resistors R₂₄₂, R₂₄₄, and R₂₄₆, which correspond to the portions of the solar control layer over the mesas, remain electrically disconnected from each other and the portion of the solar control layer within the interconnected trench.

FIG. 4 includes an illustration of an alternative embodiment in which a solar control layer 400 is a continuous layer that is formed over the textured substrate 200. In the embodiment of FIG. 4, portions 442, 444, and 446 of the solar control layer are disposed over the top surfaces of the textured substrate 200 outside of the trenches 220. Portions 462 and 464 of the solar control layer are disposed over the bottom surfaces of the trenches 220. In this embodiment, portions 452, 454, 456, and 458 are disposed along the sidewalls 222 of the trenches 220 between portions of the solar control layer 200 that lie along the bottom surfaces of the trenches and other portions that lie outside the trenches 220. The thickness of the each of portions 452, 454, 456, and 458 is substantially thinner than the thickness of the each of portions 442, 444, 446, 462, and 464.

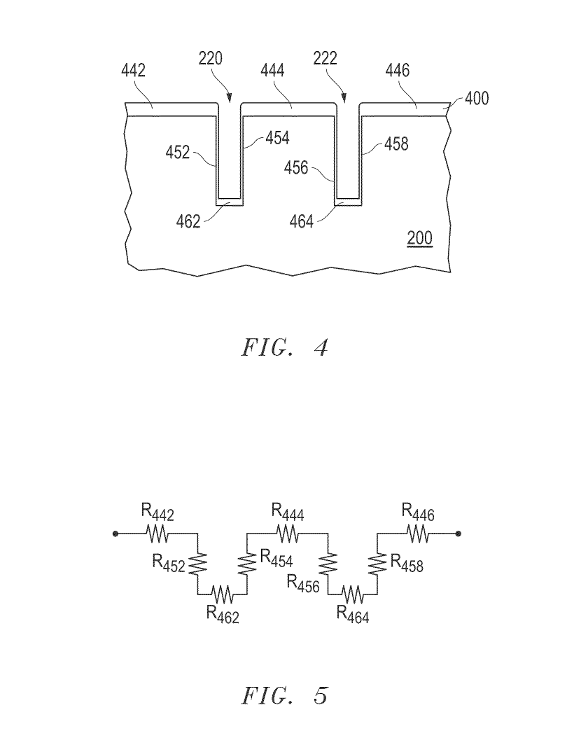

When the embodiment of FIG. 4 is electrically modeled, each of the portions can have corresponding resistances R₄₄₂, R₄₄₄, R₄₄₆, R₄₅₂, R₄₅₄, R₄₅₆, R₄₅₈, R₄₆₂, and R₄₆₄ as illustrated in FIG. 5. The resistors are connected in series because the solar control layer 400 is continuous along the textured substrate 400. Because the thicknesses of portions 452, 454, 456, and 458 are substantially thinner than the portions 442, 444, 446, 462, and 464, each of R₄₅₂, R₄₅₄. R₄₅₆, and R₄₅₈ is significantly greater than each of R₄₄₂, R₄₄₄, R₄₄₆, R₄₆₂, and R₄₆₄, the equivalent resistance within the circuit is dominated by R₄₅₂, R₄₅₄. R₄₅₆, and R₄₅₈, which correspond to the sidewall portions 452, 454, 456, and 458. Thus, if a voltage difference were to be applied across the solar control layer between the portions 442 and 446, current would flow, but such current is very low. Referring to FIG. 1, such a situation corresponds to sheet resistance lower than the embodiment in FIG. 2, but the embodiment in FIG. 4 can have an effective sheet resistance corresponding to at least 1000 ohms/square due to the thin sidewall portions 452, 454, 456, and 458. The transmission loss through the solar control layer 400 may be no greater than −1 dB. Therefore, if portions of a solar control layer are deposited on sidewalls of trenches 220 of the textured substrate 200, transmission loss for wireless communications can still be within an acceptable limit.

Attention is now directed to illustrative, non-limiting embodiments for fabrication processes that can be used to form a transparent composite that has a solar control layer. While much of the discussion is directed to a transparent composite in the form of a film to be applied to a window, variations can be made to the process so that the solar control layer is formed within or on a window.

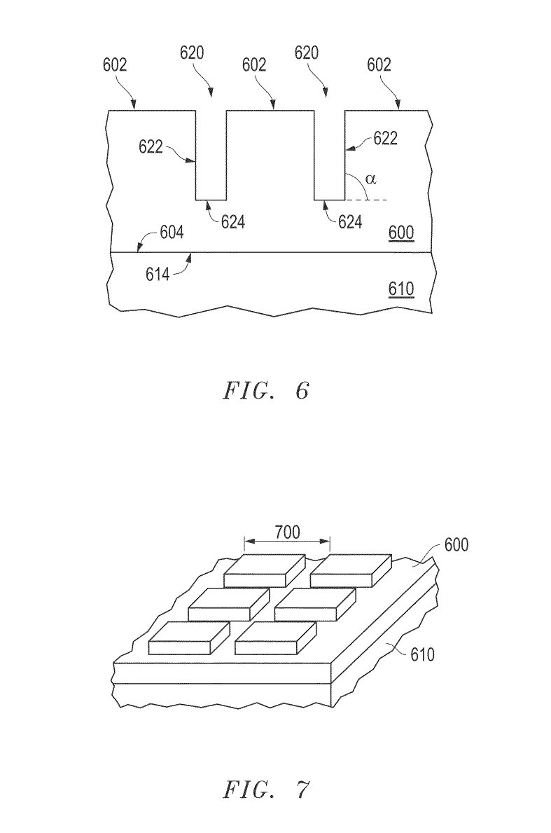

The method of forming a transparent composite can start with providing a textured substrate. Referring to FIG. 6, a textured substrate 600 has major surfaces 602 and 604 that are substantially parallel to one another. The textured substrate 600 has a thickness that is the distance between the major surfaces 602 and 604, which is in a vertical direction for the embodiment as illustrated in FIG. 6. In one embodiment, the thickness of the textured substrate 600 is at least 110 nm, at least 200 nm, at least 500 nm, or at least 1.1 microns, and in another embodiment, the thickness of the textured substrate is no greater than 20 microns, or no greater than 9 microns, or no greater than 7 microns. The textured substrate 600 can have a thickness in a range of any of the maximum and minimum values described above, such as, from 110 nm to 20 microns, 500 nm to 9 microns, or 1.1 microns to 7 microns.

The textured substrate 600 can include an organic or inorganic material. In an embodiment, the textured substrate 600 can include a transparent polymer. The transparent polymer can include a polyacrylate, a polyester, a polycarbonate, a polysiloxane, a polyether, a polyvinyl compound, another suitable class of transparent polymer, or a mixture thereof.

In a particular embodiment, the transparent polymer includes a polyacrylate. The polyacrylate can be a poly(methylacrylate), a poly(ethylacrylate), a poly(propylacrylate), a poly(vinylacrylate), a poly(methyl methacrylate), a poly(ethyl methacrylate), a poly(propyl methacrylate), a poly(vinyl methacrylate), or a mixture thereof. In another embodiment, the polyacrylate can be a copolymer of two, three, or more acrylic precursors. The acrylic precursors can include methyl acrylate, ethyl acrylate, propyl acrylate, vinyl acrylate, methyl methacrylate, ethyl methacrylate, propyl methacrylate, vinyl methacrylate. For example a copolymeric polyacrylate can include poly(methyl methacrylate vinyl methacrylate). In one particular embodiment, the transparent polymer comprises poly(methyl methacrylate). In one other particular embodiment, the transparent polymer consists essentially of poly(methyl methacrylate). In one further embodiment, the transparent polymer comprises poly(vinyl methacrylate). In one other particular embodiment, the transparent polymer consists essentially of poly(vinyl methacrylate).

In one embodiment, the transparent polymer includes a polyester. The polyester can include a polyethylene terephthalate (PET), a polyethylene napthalate, a polybutylene terephthalate, a polyethylene isonaphthalate, or any combination thereof. In one particular embodiment, the transparent polymer comprises PET. In another particular embodiment, the transparent polymer consists essentially of PET.

In one embodiment, the transparent polymer includes a polyether. The polyether can be polyethylene ether, poly propylene ether, polybutylene ether, or any combination thereof. In another embodiment, the polyether can be a copolymer of two, three, or more polyols. For example, the polyether can be a copolymer of 1,2-ethanediol, 1,2-propanediol, 1,3-propanediol, 1,2-butanediol, 1,3-butanediol, 1,4-butanediol.

In one embodiment, the transparent polymer can be a polyvinyl compound. The polyvinyl compound can be a polyvinyl alcohol, a polyvinyl ester, a polyvinyl acetal, or any combination thereof. In one embodiment, the polyvinyl acetal can include polyvinyl butyral. In one particular embodiment, the transparent polymer consists essentially of polyvinyl butyral. In another embodiment, the polyvinyl compound can be a copolymer of a vinyl alcohol derivative and an olefin. The vinyl alcohol derivative can be vinyl acetate. In one embodiment, the polyvinyl compound can be poly(ethylene vinyl acetate).

In yet one further embodiment, the transparent polymer can have a refractive index that is equal or within 0.03 units from an adjacent layer. For example, if an adjacent layer is glass having a refractive index between 1.47 and 1.55, the transparent polymer can be made of a material that is within 0.03 units of the refractive index of the glass. In one embodiment, an adjacent layer can have a refractive index of 1.49 and the transparent polymer can be of a material having a refractive index of about 1.49. For example, the transparent polymer can be poly(methyl methacrylate) with a refractive index of 1.49. In another embodiment, an adjacent layer can have a refractive index of 1.55 and the transparent polymer can be of a material having a refractive index of about 1.57. For example, the transparent polymer can be poly(ethylene terephthalate) with a refractive index of 1.57. In a more particular embodiment, the textured substrate 600 includes a polyalkylmethacrylate, wherein the alkyl group has 1 to 3 carbon atoms.

In a particular embodiment in which haze is a concern, the textured substrate 600 does not include a polyolefin, such as polyethylene, due at least in part to the crystalline and amorphous phases having significantly different refractive indices causing a high level of haze. In an embodiment, the textured substrate 600 can include nanoparticles such as silica, TiO₂, ITO, SnO₂ doped with Sb. The nanoparticles are aimed at increasing (in the case of ITO, SnO₂ doped with Sb), TiO₂) or decreasing (in the case of silica) the refractive index of the textured substrate 600. In another embodiment, the textured substrate 600 can include a glass, a sapphire, a spinel, or an aluminum oxynitride (“AlON”).

In another embodiment, the textured substrate 600 may have a thickness greater than 1 mm and may be self-supporting, and a support substrate, such as support substrate 610, may not be needed. In many embodiments, the textured substrate 600 will be significantly thinner than 1 mm, and a support substrate 610 can be used. The thickness and composition of the support substrate 610 can be determined based on the application. When the transparent composite produced is a film to be applied to a window, the support substrate 610 may be flexible. In one embodiment, the support substrate 610 can have a thickness of at least 11 microns, at least 17 microns, or at least 25 microns, and in another embodiment, the thickness of the support substrate 610 may be no greater than 900 microns, no greater than 600 microns, or no greater than 300 microns. The support substrate 610 can have a thickness in a range of any of the maximum and minimum values described above, such as, from 11 microns to 900 microns, 17 microns to 600 microns, or 25 microns to 300 microns. The support substrate 610 can include any of the material previously described with respect to the textured substrate 600. In an embodiment, the support substrate 610 has a different composition than the textured substrate 600. For example, the support substrate 610 includes PET.

The textured substrate 600 defines trenches 620 having bottom surfaces 624 and sidewalls between the major surface 602 and the bottom surfaces 624. In the embodiment as illustrated in FIG. 6, the bottom surfaces 624 are substantially parallel to the major surface 602, and the sidewalls 622 have a sidewall angle noted by alpha (α) in FIG. 6. The sidewall angle is ideally 90°; however, the sidewall angle does not have to be 90°. The sidewall angle can be at least 50°, at least 80°, at least 85°, at least 88°, or at least 89°. The sidewall angle can be in a range of any of the maximum and minimum values described above, such as, from 50° to 90°, 80° to 90°, 85° to 90°, 88° to 90°, or 89° to 90°. In applications where the solar control layer is not to be formed on the sidewall or is to be relatively thin if deposited, the sidewall angle can be at least 85°, and the sidewall angle is in a range of 85° to 90°. In a particular embodiment where haze is to be reduced, the sidewall angle can be close to 90°, such as in a range from 88° to 90°. Although not illustrated, corners of the trenches 620 may be rounded near the major surface 602 or the bottom surfaces 624.

The trenches 620 have depths that are measured from an elevation corresponding to the major surface 602 to an elevation of the bottom surfaces 620. The depths of the trenches 620 can be significantly greater than the thickness of a subsequently-formed solar control layer, so that discrete, spaced-apart portions of the solar control layer overlie the major surface 602 and the bottom surfaces 624, or the thickness of the solar control layer along the sidewalls 622 is substantially thinner than portions of the solar control layer overlying the major surface 602 or the bottom surfaces 624. The trenches 620 may extend completely through or through only a portion of the thickness of the textured substrate 600. In another embodiment, the trenches 620 may extend through substantially all of the textured substrate 620. In an embodiment, the trenches 620 have a depth of at least 50 nm, at least 300 nm, or at least 1000 nm, and in another embodiment, the depth is no greater than 10 microns, no greater than 4 microns, or no greater than 1 micron. The depths of the trenches can be in a range of any of the maximum and minimum values described above, such as, from 50 nm to 10 microns, 300 nm to 4 microns.

The widths of the trenches 620 may be used to control the effective sheet resistance of a subsequently-formed solar control layer. The sheet resistance of the solar control layer may be 20 ohms/square along a flat surface with a large area. If the width of the layer is reduced by 90%, the effective sheet resistance becomes 200 ohms/square. Thus, from a top view, the percentage of the area within the trenches 620 to the total surface area over which the solar control layer is formed can be used to adjust the effective sheet resistance to a needed or desire value for a particular composition of the solar control layer. In an embodiment, from a top view, a percentage of the area along the bottom surfaces 624 of the trenches 620 to the surface area of the textured substrate is no greater than 50%, no greater than 1%, or no greater than 0.01%, and in another embodiment, the percentage is at least 1×10⁻⁵%, at least 1×10⁻⁴%, or at least 1×10⁻³% The percentage of the area along the bottom surfaces 624 of the trenches 620 to the surface area of the textured substrate can be in a range of any of the maximum and minimum values described above, such as, from 1×10⁻⁵% to 50%, 1×10⁻⁴% to 1%, or 1×10⁻³% to 0.01%.

In another embodiment, the different portions of the solar control layer do not contact conductive portions of a frame or another structural member supporting a window. In this embodiment, the sheet resistance of the solar control layer may not be a significant issue.

In an embodiment, widths of the trenches are measured at a midpoint along the trenches and are no greater than 90 microns, no greater than 70 microns, or no greater than 50 microns, or no greater than 30 microns, no greater than 9 microns, and no greater than 5 microns, and in another embodiment, the widths are at least 0.11 micron, at least 1.1 microns, at least 2 microns, at least 3 microns, at least 4 microns, at least 5 microns, or at least 11 microns. The widths can be in a range of any of the maximum and minimum values described above, such as, from 0.11 micron to 90 microns, 1.1 microns to 70 microns, at least 5 microns to 50 microns, or 2 microns to 30 microns, or 3 microns to 9 microns.

FIG. 7 includes a perspective view at this point in processing. Note that the depictions in FIGS. 6 and 7 are merely to illustrate an exemplary embodiment and are not drawn to scale. Referring to FIG. 7, bottom surfaces 624 of the trenches 620 correspond to the lower exposed surface of the textured substrate 600. Thus, in a particular embodiment, only a single trench is defined and portions of the textured substrate above the lower exposed surface of the textured substrate 600 are mesas with the upper surfaces that correspond to the major surface 602 in FIG. 6. The embodiment illustrated in FIG. 7 has a pitch 700 that is a sum of a feature (width of a mesa) and a space (width of the trench). In an embodiment, the pitch 700 is at least 0.11 micron, at least 0.5 micron, or at least 1.1 microns or at least 5 microns, at least 1.1 mm, at least 2 mm, and in another embodiment, the pitch 700 is no greater than 9 cm no greater than 9 mm, no greater than 5 mm, no greater than 4 mm, or no greater than 900 microns. The pitch 700 can be in a range of any of the maximum and minimum values described above, such as, from 0.11 micron to 9 cm, 0.5 microns to 9 mm, 1.1 microns to 5 mm, or 2 mm to 4 mm.

The textured substrate can be formed many different ways, which may in part, depend on the material of the textured substrate and the pattern of the textured substrate. In an embodiment, the textured substrate can include a polymer and be formed using a mold or a die. In a particular embodiment, the textured substrate 600 may be formed coating a polymer layer over the support substrate 610 and embossing the surface with a mold while the polymer layer is cured. The curing can be performed with radiation, such as ultraviolet radiation, or with heat (i.e., thermal curing). In another embodiment, the mold can be placed over the support substrate 610, and the textured substrate can be injection molded over the support substrate 610. In a further embodiment, a layer of the polymer may be formed and transfer molded into the textured substrate 600 when over the support substrate 610 or separate from the support substrate 610. The textured substrate 600 has mesas and an interconnected trench between the mesas.

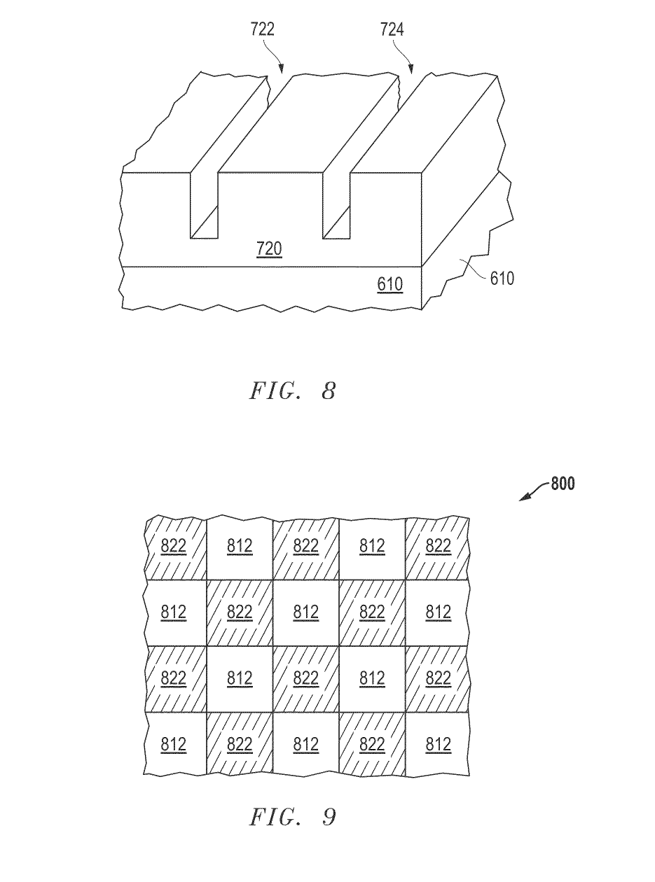

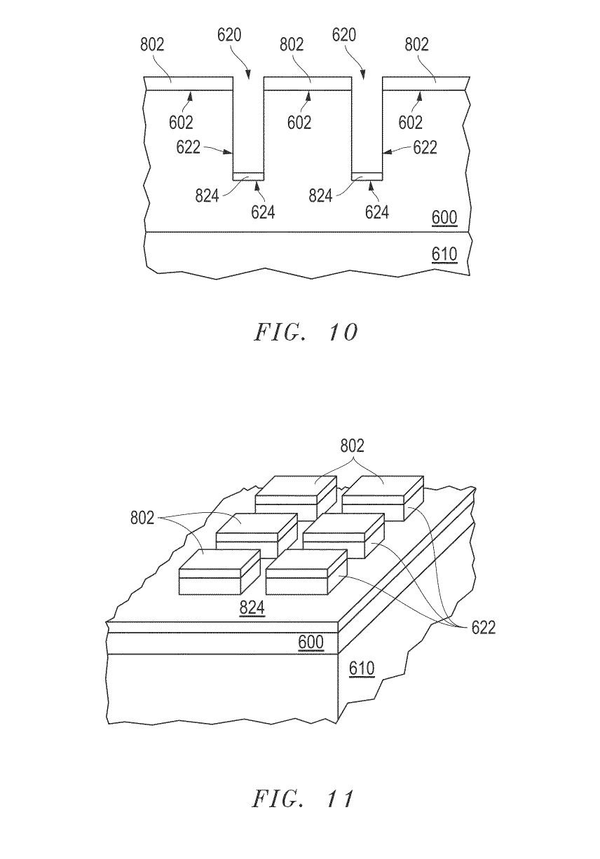

In another embodiment as illustrated in FIG. 8, the textured substrate 720 may be extruded by itself or coextruded with the support substrate 610 to form the partly completed workpiece. In this embodiment, a die can have a shape corresponding to the shape of the textured substrate 720, and the spaced-apart (not interconnected) trenches 722 and 724 can extend in a direction in which the textured substrate 720 was extruded. In a further embodiment, a checkerboard pattern may be formed as illustrated in FIG. 9 that includes a top view of a portion of a partly completed workpiece that includes textured substrate 800 with a checkerboard pattern including mesas 812 and recessions 822. The pattern of textured substrate 800 can be formed using any of the techniques used to form the textured substrate 600.

Other techniques may used to form the textured substrate that includes a polymer or another material, such as an inorganic material. In an embodiment, an initial substrate has a surface that is generally planar, and a portion of the initial substrate is removed to form the textured substrate. The removal may be performed using a laser or ion beam or may be performed using a mask-and-etch technique. In another embodiment, the textured substrate may be formed using an additive (that is, adding material) rather than a subtractive (that is, removing material) process. In an embodiment, the initial substrate can have a transparent material selectively formed over the initial substrate to form the textured substrate. Referring to FIG. 7, such a process would form the mesas over the initial substrate to form the texture substrate 610. In a particular embodiment, a stencil mask can be placed over the surface of the initial substrate, and the transparent material can be deposited through openings in the stencil mask such that a shape of the transparent material corresponds to a shape of the openings in forming the mesas. Other formation techniques may be used without departing from the scope of the appended claims.

The processing sequence that follows is based on the textured substrate 600 and support substrate 610 as illustrated in FIGS. 6 and 7. The processing for other textured substrates, such as the textured substrates in FIGS. 8 and 9, can be performed substantially as described with respect to FIGS. 6 and 7.

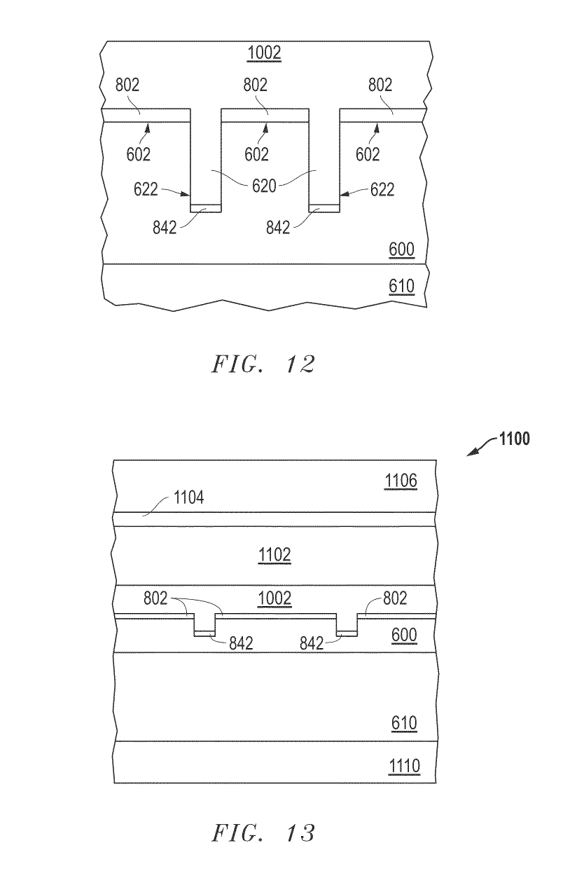

A solar control layer can be formed over the textured substrate 600 as illustrated in FIG. 10. The solar control layer includes portions 802 lying along the major surface 602, and portions 824 lying along the bottom surfaces 624 of the trenches 620. As illustrated in FIGS. 10 and 11, the solar control layer does not lie along substantially all of the sidewalls 622, and therefore, in the embodiment as illustrated in FIG. 11, portions of the sidewalls 622 are exposed between the portions 802 and 824 of the solar control layer. Although the solar control layer can include one or more layers of a conductive material, the portions 802 are spaced apart from one another and the portion 824. Thus, the portions 802 and 824 are not electrically connected to each other. From a top view in a direction perpendicular to the major surface 602, the portions 802 do not overlie the portion 824. In another embodiment, only a small fraction, such as less than 5% of the portions 802 overlie the portion 824.

The solar control layer can be formed using a technique that forms the solar control layer more readily along horizontal surfaces, such as the major surface 602 and bottom surfaces 624 of the trenches 620, as compared to vertical surfaces, such as the sidewalls 622 of the trenches 620. The solar control layer can be non-conformally deposited over the textured substrate 620. In an embodiment, the non-conformal deposition is performed under vacuum using a physical vapor deposition or chemical vapor deposition technique. In a particular embodiment, the non-conformal deposition is performed using sputtering, ion beam deposition, plating, or plasma-enhanced chemical vapor deposition. In a particular embodiment, the solar control lay can be formed by DC magnetron, pulsed DC, dual pulsed DC, or dual pulsed AC sputtering using rotatable or planar targets made of metal or ceramic metal oxide. If needed or desired, a collimator or another similar device can be used when sputtering to help prevent or reduce deposition of the solar control layer along the sidewalls 622.

The solar control layer can be deposited to a thickness such that the portions 802 do not contact the portion 824. The thickness may be expressed in terms of the depth of the trench, wherein the thickness is measured over the major surface 602 spaced apart from the sidewalls 622 (to reduce proximity effects). In an embodiment, the solar control layer has a thickness that is no greater than 80%, no greater than 50%, no greater than 40%, no greater than 30%, or no greater than 9% of the elevational difference between the major surface 602 and the bottom surface 624. In another embodiment, the solar control layer has a thickness that is at least 0.02%, at least 0.05%, at least 0.2%, at least 0.5%, at least 2%, at least 11%, or at least 20% of the elevational difference between the major surface 602 and the bottom surface 624. The percentage of the elevational difference between the major surface 602 and the bottom surface 624 can be in a range of any of the maximum and minimum values described above, such as, from 0.02% to 80%, 0.05% to 30%, or 0.2% to 9% of the elevational difference between the major surface 602 and the bottom surface 624. Alternatively, the thickness of the solar control layer may be expressed in a unit of measure, rather than on a relative basis. In an embodiment, the solar control layer has a thickness that is no greater than 1500 nm, no greater than 400 nm, no greater than 160 nm, no greater than 100 nm, and in another embodiment, the solar control layer has a thickness that is at least 10 nm, at least 20 nm, at least 40 nm, or at least 200 nm. The thickness can be in a range of any of the maximum and minimum values described above, such as, from 10 nm to 1500 nm, 20 nm to 400 nm, 40 nm to 160 nm, or 50 nm to 100 nm.

The number of layer, compositions, and thicknesses of the layers within the solar control layer are selected to allow substantial transmission of visible light while attenuating a significant amount of near IR radiation. The layers within the solar control layer can include silver-based layers, metal-based layers (other than silver-based layers), metal oxide layers, metal nitride layers and may further include barrier layers. Any of the one or more silver-based layers described above can contain silver, and in particular embodiments can consist essentially of silver. As used herein, the phrase “consist essentially of silver” refers to a silver based layer containing at least 95 atomic % silver. In other embodiments, the one or more silver-based layer may have no greater than 30 atomic %, no greater than 20 atomic %, or even no greater than 10 atomic % of another metal, such as, gold, platinum, palladium, copper, aluminum, indium, zinc, or any combination thereof. Any of the one or more metal-based layers described herein can consist essentially of a metal. As used herein, the phrase “consisting essentially of a metal” refers to at least 95 atomic % of the metal.

Any of the one or more silver-based layers can have a thickness of at least 0.1 nm, at least 0.5 nm, or even at least 1 nm. Furthermore, any of the one or more silver-based layers may have a thickness of no greater than about 100 nm, no greater than 50 nm, no greater than 25 nm, or even no greater than 20 nm. Moreover, any of the one or more silver-based layers can have a thickness in a range of any of the maximum and minimum values described above, such as from 0.5 nm to about 25 nm, or even from 1 nm to 20 nm.

In an embodiment, any of the one or more metal based layers described herein can contain an essentially pure metal or in other embodiments, a metal alloy. In other embodiments, any of the one or more metal based layers can contain a metal alloy, such as for example containing a predominant metal in a concentration of at least 70 atomic %, and a minor metal in a concentration of less than 30 atomic % based on the total weight of the metal based layer. Any of the one more metal based layers described herein can contain a metal including gold, titanium, aluminum, platinum, palladium, copper, indium, zinc or combinations thereof. In a particular embodiment, any one of the one more metal based layers described herein can contain gold. In other particular embodiments, the metal based layer(s) can be essentially free of gold. As used herein, the phrase “essentially free of gold” refers to a metal based layer containing less than 5 atomic % gold.

Any of the one or more metal-based layers described above can have a thickness that allows the metal-based layers to be substantially transparent and provide sufficient protection to the silver-based layer. In a particular embodiment, any of the one or more metal-based layers described above can have a thickness of at least 0.1 nm, at least 0.5 nm, or even at least 1 nm. Further, any of the one or more metal-based layers described above may have a thickness of no greater than 100 nm, no greater than 55 nm, no greater than 5 nm, or even no greater than about 2 nm.

Any of the one or more metal-based layers described above can have the same thicknesses or can have a different thickness. In a particular embodiment, each of the one or more metal-based layers have the substantially the same thickness. As used herein, “substantially the same thickness” refers to a thicknesses that are within 10% of each other. The metal oxide based layer can be disposed adjacent to, or even, directly contacting a major surface of a metal based layer opposite the silver based layer.

Any of the one or more metal oxide layer(s) discussed above can contain a metal oxide such as a titanium oxide (for example, TiO₂), an aluminum oxide, BiO₂, PbO, NbO, SnZnO, SnO₂, SiO₂, ZnO, or any combination thereof. In a particular embodiment, a metal oxide layer can contain and even be substantially composed of a titanium oxide or an aluminum oxide. The metal oxide layer(s) can have a thickness of at least about 0.5 nm, at least 1 nm, or at least 2 nm, and in another embodiment, may have a thickness of no greater than 100 nm, no greater than 50 nm, no greater than 20 nm, or even no greater than 10 nm. Moreover, any of the one or more metal oxide layer(s) discussed above can have a thickness in a range of any of the maximum and minimum values described above, such as, from 0.5 nm to 100 nm, or even from 2 nm to 50 nm.

FIG. 12 includes an illustration after a trench-fill material 1002 fills a remainder of the trenches 620. In the embodiment as illustrated in FIG. 12, the trench-fill material 1002 also overlies portions 802 of the solar control layer. The thickness of the trench-fill material 1002 over the portions 802 can be at least 0.2 micron, at least 0.5 micron, at least 0.8 micron or at least 1.1 microns, and in another embodiment, the thickness is no greater than 7 microns, no greater than 5 microns, no greater than 4 microns, or no greater than 3 microns. The thickness can be in a range of any of the maximum and minimum values described above, such as, from 0.2 micron to 7 microns, 0.5 micron to 5 microns, 0.8 micron to 4 microns, or 1.1 microns to 3 microns. In another embodiment, substantially none of the trench-fill material 1002 overlies the portions 802. In such an embodiment, the upper surface of the trench-fill material 1002 can be at an elevation between elevations of the major surface 602 and upper surfaces of the portions 802 near the trenches 620. In an embodiment in which haze is a concern, the trench-fill material 1002 can fill the trenches 620 and overlying the portions 802 to reduce the number of interfaces of materials within and immediately above the trenches 620, such as illustrated in FIG. 12.

In a particular embodiment, haze can be further reduced when the refractive indices of the textured substrate 600 and the trench-fill material 1002 are the same. If the thickness of the trench-fill material 1002 would be less than 300 nm, the refractive indices between the textured substrate 600 and the subsequently-formed clear weatherable layer can be the same. If the distance between the bottom of the trench 624 (FIG. 6) and the support substrate 610 is less than 300 nm, that the refractive indices of the support substrate 610 and the trench-fill material 1002 can be the same.

The trench-fill material 1002 may include any of the materials as previously described with respect to the textured substrate 600. In an embodiment, the trench-fill material 1002 includes an adhesive, such as a laminating adhesive or a pressure sensitive adhesive. In an embodiment, the trench-fill material 1002 can include polyester, acrylate, polyvinyl acetate (“PVAc”), polyvinyl butyral, polyvinyl alcohol (“PVA”), silicone rubber, another suitable adhesive, or any mixture thereof. In another embodiment, the trench-fill material 1002 is not adhesive. In such an embodiment, the trench-fill material 1002 can include nanoparticles such as silica, TiO₂, ITO, SnO₂ doped with Sb. The nanoparticles are aimed at increasing (in the case of ITO, SnO₂ doped with Sb), TiO₂) or decreasing (in the case of silica) the refractive index of the trench-fill material 1002 to the refractive index of the material of the textured substrate 600 and therefore, reduce the haze. In such an embodiment, the trench-fill material 1002 can be coated and cured. This particular embodiment may need a separate adhesive layer to allow the trench-fill material 1002 to adhere to a subsequently attached layer, such as a weatherable layer.

The selection of the materials for the textured substrate 600 and trench-fill material 1002 may be performed to achieve particular properties. For example, haze may be a concern, and to reduce haze, the refractive indices of the materials for the textured substrate 600 and trench-fill material 1002 can be within 0.03 of each other, within 0.02 of each other, or within 0.01 of each other. A refractive index is determined at 20° C. with a radiation source that emits light at 589 nm (yellow light). When the refractive indices are different, the refractive index of the material of the textured substrate 600 may be higher than the trench-fill material 1002, or vice versa. In a particular embodiment, the textured substrate 600 can include an acrylate that has a refractive index of about 1.49, and the trench-fill material 1002 can include PVAc that has a refractive index of about 1.47. In another particular embodiment, the textured substrate 600 can include glass (SiO₂) that has a refractive index of about 1.54, and the trench-fill material 1002 can include PVA that has a refractive index of about 1.53. Thus, after reading this specification, skilled artisans will be able to determined matched pairs of materials for the textured substrate 600 and trench-fill material 1002 to achieve relatively low haze.

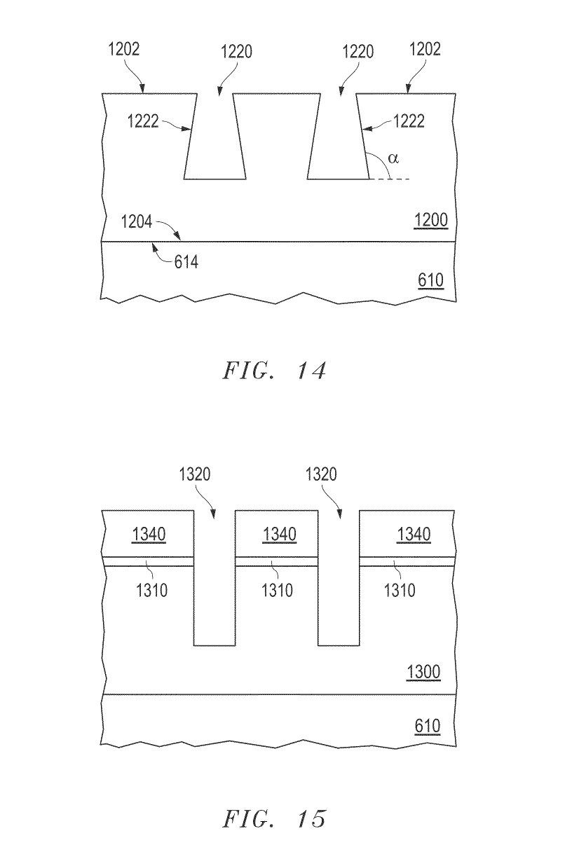

FIG. 13 includes an illustration of a substantially completed transparent composite 1100, which can be a transparent film designed to be applied to a window (not illustrated). A hard coat layer 1110 lies along the support substrate 610 on a surface opposite the textured substrate 600. The hard coat layer 1110 can provide improvement in abrasion resistance, so that the support layer 610 is less likely to be scratched. The hard coat layer 1100 can include a cross-linked acrylate, an acrylate containing nanoparticles, such as SiO₂ or Al₂O₃, or any combination thereof. The hard coat layer 1110 can have a thickness in a range of 1 micron to 5 microns.

The transparent composite 1100 can further include a clear weatherable layer 1102 over the trench-fill material 1002. The clear weatherable layer 1102 helps to protect the solar control layer. The clear weatherable layer 1102 has high transmission of visible layer and is relatively resistant to yellowing or cracking over long term exposure to the sun. The clear weatherable layer 1002 can include any of the materials as previously described with respect to the support substrate 610. The clear weatherable layer 1102 can have a thickness in a range of 10 microns to 50 microns. When the trench-fill material 1002 is a laminating adhesive or a pressure sensitive adhesive, the clear weatherable layer 1102 can be applied to the trench-fill material 1002. When the trench-fill material 1002 is not adhesive, an adhesive, such as a pressure sensitive adhesive, can be used to adhere the clear weatherable layer 1102 to the trench-fill material 1002.

An adhesive layer 1104 is disposed between the clear weatherable layer 1102 and a release layer 1106. The adhesive layer 1104 can include any of the adhesive materials and thicknesses as previously described with respect to the trench-fill material 1002 when the trench-fill material 1002 is an adhesive. In another embodiment, the adhesive layer 1104 can include any adhesive that is clear and has at least 85% transparency to visible light for the particular thickness of the adhesive layer 1104. In one embodiment, the adhesive layer is a pressure sensitive adhesive. In some cases, once installed on a window, the adhesive layer 1104 is the first layer within the transparent composite to be crossed by the sunlight. In such case, a UV resistant layer can be used as the adhesive layer 1104 such as an acrylate. An additive, such as a UV absorber, can be added in order to increase durability of the whole transparent composite 1100. The release liner 1106 protects the adhesive layer 1104 during shipping and handling of the transparent composite 1100. The release liner 1106 will be removed before the transparent composite 1100 is applied to a window. Thus, the transmissive properties of the release liner 1106 are not important; the release liner 1106 can be opaque to visible light or can be translucent. Therefore, the composition and thickness of the release layer 1106 is not critical. In a particular embodiment where the transparent composite 1100 is stored as a roll, the thickness of the release liner 1106 is selected to allow the transparent composite 1100 to be flexible. In another embodiment, the release liner 1106 is not used. For example, the transparent composite 1100 may be installed onto a window shortly after the transparent composite 1100 is fabricated. After the adhesive layer 1104 is applied, the transparent composite 1100 is installed onto a window.

In a different embodiment, a transparent composite can be fabricated on or using a window. In a particular embodiment, the support substrate 610 and hard coat layer 610 can be replaced by the window. The window can include a glass, a sapphire, spinel, AlON, or any composite of the foregoing, such as transparent armor. The textured substrate 600 can be formed on or applied to the surface of the window. The solar control layer can be formed as previously described. The trench fill material 1002 and clear weatherable layer 1104 as previously described can be used. In this embodiment, the clear weatherable layer 1104 may have a thickness up to 1000 microns. A hard coat layer would then be formed on the clear weatherable layer 1104, wherein the hard coat layer has a composition and thickness as previously described with respect to the hard coat layer 1110.

In another different embodiment, the window may also replace the textured substrate 600. In this embodiment, a surface of the window may be covered by a masking layer, and portions of the window can be etched or otherwise removed to form a surface having mesas and trenches are previously described with respect to the textured substrate 600. After removing the mask, fabrication of the solar control layer, clear weatherable layer, and hard coat layer are substantially the same as described in the prior embodiment. In a further embodiment, the window can be textured by using a stencil mask and selectively depositing a transparent material onto the window to achieve a textured substrate. In a further embodiment, the textured substrate 600 can include glass. After forming the solar control layer, the remainder of the trenches can be filled with a trench-fill material that includes polyvinyl butyral (PVB) doped with nanoparticles to increase the refractive index of the trench-fill material to be closer to or the same as the glass.

Referring to FIG. 4, when forming the solar control layer in particular embodiments, some deposition along the sidewall may occur. Such sidewall deposition is not problematic provided the resistance of the sidewall portions of the solar control layer is sufficiently high. As used herein, step coverage is the percentage of the minimum thickness of a layer along a sidewall, as measured perpendicular to the sidewall, divided by the thickness of the layer along a horizontal surface space apart from any topology changes. In an embodiment, such as the one illustrated in FIG. 4, the step coverage may be no greater than 50%. In another embodiment, the step coverage can be less than 20%, less than 9%, less than 5%, or less than 0.9%. When step coverage is 0%, the layer is discontinuous along the sidewall. Thus, FIG. 2 illustrates an embodiment in which step coverage is 0%.

Although a sidewall angle of 90° should not have any sidewall deposition, some of the solar control layer may become deposited on the sidewall even when the sidewall angle is 90°. If discontinuity of the solar control layer is needed or desired, the shapes of the trenches may be changed such that the widths of the trenches at the tops of the trenches are less than the widths of the trenches at locations spaced apart from the tops of the trenches. Referring to FIG. 14, a textured substrate 1200 has major surfaces 1202 and 1204 and trenches 1220 that have a dovetailed shape. The trenches 1220 have sidewalls 1222 that have a sidewall angle alpha (α) that is an obtuse angle. The sidewall angle can be in a range of 90° to 120°. The textured substrate 600 can be formed by extrusion having a die with a pattern corresponding to the dovetailed-shaped trenches 1220.

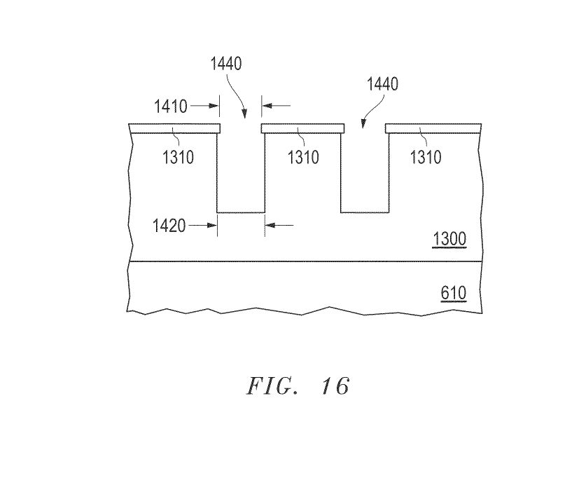

In another embodiment, a trench having an undercut portion may be formed. Referring to FIG. 15, a body layer 1300 and a capping layer 1310 are formed over the support substrate 610. In a particular embodiment, the support substrate 610 can be a window, the body layer 1300 can include doped glass, and the capping layer 1310 can include an undoped glass layer. A masking layer 1340 can be formed over the capping layer 1310 and patterned to form openings corresponding to locations where the trenches 1320 will be formed. The capping layer 1310 and body layer 1300 can be anisotropically etched to form the trenches 1320 having substantially vertical sidewalls. The workpiece can be exposed to an isotropic etchant that etches the body layer 1400 faster than the capping layer 1410 as illustrated in FIG. 16. In a particular embodiment, the body layer 1300 can be a phosphorus doped glass, and the etchant can be a HF acid solution, as phosphorus doped glass etches faster than undoped glass when exposed to the HF acid solution. Thus, the widths 1440 of the trenches 1420 within the body layer 1400 are wider than the widths 1410 of the trenches 1420 within the capping layer 1410. The masking layer 1340 may be removed before or after the exposure to the HF acid solution.

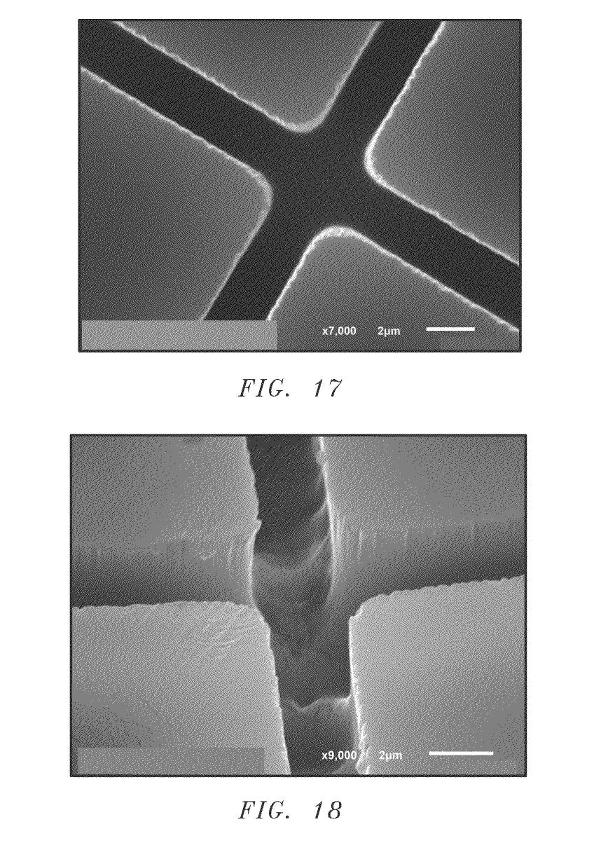

FIGS. 17 and 18 include scanning electron microscope images of a textured substrate formed using an embossing technique and a metal layer non-conformally deposited over the textured substrate. The trenches have widths of 2.2 microns to 2.4 microns and depths less than 5 microns. The depths of the trenches can be in a range of 3.5 to 4.5 microns. In other embodiments, the values for the widths and depths can be different.

For each of the embodiments described and illustrated in FIGS. 14 and 16 to 18, the solar control layer and trench-fill material 1002 are formed as previously described. The solar control layer will have discontinuous portions due to the shapes of the trenches. In particular, the trench is wider at a point spaced apart from the top surface as compared to at the top surface of the textured substrate. In FIG. 14, the width of the trench at the bottom is the same as at an elevation midway between the top and bottom of the trench. In FIG. 16, the trench is wider at a bottom of the trench as compared to at an elevation midway between the top and bottom of the trench. In FIG. 18, the trenches are bowed outwardly from centerlines extending vertically within the trench (perpendicular to the top surface of the textured substrate), such that the widths are greatest at an elevation between the top and bottom the trenches. Any of the profiles of the trenches in FIGS. 14, 16, and 18 can be useful in forming the solar control layer such that the solar control layer will be discontinuous along the walls of the trenches.

Another sheet of glass can be attached to the embodiments as described and illustrated in FIGS. 14 to 18. A PVB layer can be applied to the glass layer, and glass layer and the textured substrate with the solar control layer are pressed together. The PVB layer may include nanoparticles to allow for better matching of refractive indices of the PVB to the glass layer.

Embodiments as described herein have advantages over the other structures and processes. When viewed in a direction normal to the surface, there are no lateral gaps in coverage of the solar control layer. A conventional window film, such as disclosed in JP 2005-104793, can deposit a solar control layer followed by a crushing or other otherwise breaking or fracturing the layer to break the solar control layer into divided pieces in order to electrically disconnect portions of the solar control layer from one another. Other conventional window films can include films with nanoparticles. Still other conventional window films can have portions of their solar control layers removed by laser ablation or other removal techniques. Lateral gaps between portions of the solar control layer (the divided pieces, nanoparticles, or laser ablated solar control layer) can allow significant near IR radiation to pass through the convention window films.

In another embodiment, the width and aspect ratios (ratio of depth to width) of the trenches within the textured substrate are such that none of the solar control layer or a less of thickness of the solar control layer is formed along the bottom surfaces of the trenches. In a particular embodiment, the textured substrate can be moved at a velocity relative to the target, such that little or none of the solar control layer is formed along the bottom surfaces of the trenches. In a further embodiment, the workpiece can be tilted relative to the target, so that the sputtered material is deposited at an angle that is not orthogonal to a major surface of the textured substrate. In another particular embodiment, the width of the trenches can be less than 5 microns, less than 4 microns, less than 3 microns, less than 1.5 microns, less than 1 micron, or less than 0.5 micron, and in a further particular embodiment, the aspect ratio is at least 1:1, at least 1.5:1, at least 2:1, at least 4:1 or at least 8:1. As measured within the center of the trench, the thickness along the bottom of the trench is no greater than 70%, 50%, 30%, or 9% of the thickness of the solar control layer over an adjacent mesa.

As described above, the novel transparent composite includes a textured substrate over which a solar control layer is formed. As formed, the solar control layer includes portions that are spaced apart and electrically disconnected from one another or such portions have a sufficiently high effective sheet resistance so that attenuation of high frequency signals is acceptably low. Thus, transparent composite in accordance with embodiment described herein will not have lateral gaps between portions of the solar control layer, and thus, are well suited to reduce transmission of near IR radiation. Therefore, embodiments as described herein may be able to achieve LTSHGC of at least 1.05, at least 1.3, at least 1.4, at least 1.5, or at least 1.6 and attention of no greater than 10 dB, no greater than 8 dB, or no greater than 7 dB, no greater than 5 dB, no greater than 3 dB, or no greater than 1 dB for electromagnetic radiation at 1.8 GHz, 4 GHz, 6 GHz, or any frequency between, such as 4.5 GHz. Thus, good transmission of visible light and high frequency can be achieved while maintaining low transmission of near IR radiation. In one embodiment, the VLT is higher than 70%, the SHGC is lower than 47% and the attenuation of the electromagnetic radiation at 1.8 GHz is no greater than 10 dB, or no greater than 7 dB, no greater than 5 dB, no greater than 3 dB, or no greater than 1 dB. In one embodiment, the VLT is higher than 73%, the SHGC is lower than 69% and the attenuation of the electromagnetic radiation at 1.8 GHz is no greater than 10 dB, or no greater than 7 dB, no greater than 5 dB, no greater than 3 dB, or no greater than 1 dB. The process of forming the transparent composite as described herein does not involve forming multiple layers of patterned solar control layer, and hence, fewer processing operations are required. Further, from a top view, the size of the mesas and widths of the trenches can be selected so that the transparent composite has a uniform appearance to a human eye (without magnification). Thus, rows or columns or slightly lighter or darker portions of the transparent composite are not formed.

Haze of the transparent composite can be kept low by having all horizontal interfaces parallel to each other, keeping vertical interfaces close to 90° (as measured relative to horizontal interfaces), and at such vertical interfaces, matching the refractive indices of materials at opposite sides of the vertical interfaces. Hence, the embodiment as illustrated in FIG. 12 is well suited to achieve low haze. If slightly higher haze is acceptable, interfaces do not need to be vertical, such as illustrated in the embodiment of FIG. 14, the refractive indices of the materials along a vertical interface does not need to be so closely matched (greater than 0.03 for the difference between the refractive indices of the materials along a vertical interface), or any combination thereof. Thus, the orientation of the interfaces and selection of materials may be affected by the particular application for which the transparent composite will be used.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the items as listed below.

Item 1. A transparent composite comprising:

a textured substrate having a first surface and a second surface and defining a trench having a sidewall that lies between the first surface and the second surface;

a solar control layer having a first portion and a second portion, the first portion overlies the first surface, and the second portion overlies the second surface of the trench, wherein the second portion is separated from the first portion by the sidewall of the trench; and

a trench-fill material overlying extending into the trench and overlying the second portion of the solar control layer,

wherein the transparent composite has a haze no greater than 5%.

Item 2. A transparent composite comprising:

a textured substrate having a first surface and a second surface and defining a trench having a sidewall that lies between the first surface and the second surface, wherein the textured substrate has a first refractive index;

a solar control layer having a first portion and a second portion, wherein the first portion overlies the first surface, and the second portion overlies the second surface; and

a trench-fill material within the trench and overlying the second portion of the solar control layer, wherein the trench-fill material has a second refractive index,

Item 3. A transparent composite comprising:

a textured substrate having a first surface, a second surface, and a sidewall, wherein:

the sidewall extends from the first surface toward the second surface, and the trench is wider at a point spaced apart from the first surface as compared to at the first surface; and

the first surface lies at a different elevation as compared to the second surface and is separated from the second surface by at least the sidewall of the textured substrate; and

a solar control layer having a first portion and a second portion that is separated from the first portion by the sidewall of the textured substrate.

Item 4. A transparent composite comprising:

a textured substrate having a first surface, a second surface, and a sidewall, wherein:

the sidewall extends from the first surface toward the second surface and has a corresponding sidewall angle that is at least 50°; and

the first surface lies at a different elevation as compared to the second surface and is separated from the second surface by at least the sidewall of the textured substrate; and

a solar control layer having a first portion and a second portion that is separated from the first portion by the sidewall of the textured substrate.

Item 5. A transparent composite comprising:

a textured substrate having a first surface and a second surface and defining a trench having a sidewall that lies between the first surface and the second surface; and

a solar control layer having a first portion having a first thickness over the first surface and a second portion having a second thickness over the second surface, wherein as measured in a center of the trench, the second thickness is no greater than 70% of the first thickness.

Item 6. A transparent composite comprising:

a textured substrate having a first surface and a second surface and defining a trench having a sidewall that lies between the first surface and the second surface, wherein the trench has a width no greater than 4 microns and an aspect ratio of depth:width greater than 1:1; and

a solar control layer having a first portion having a first thickness over the first surface and substantially none of the solar control layer lies along the second surface within the trench.

wherein the first refractive index is within 0.03 of the second refractive index.

Item 7. A transparent composite comprising:

a textured substrate having a first surface and second surfaces, wherein the second surfaces are spaced apart from one another and lie at different elevations as compared to the first surface; and

a solar control layer includes a continuous layer overlying the first surface, wherein portions of the solar control layer overlie the second surfaces, wherein the continuous layer has an effective sheet resistance of at least 100 ohms/square.

Item 8. A transparent composite comprising:

a textured substrate having a first surface and defining a trench extending from the first surface toward a second surface of the texture substrate lying along the bottom of the trench, wherein the trench has a first width at an elevation closer to the first surface, a second width at an elevation farther from the first surface, and the second width is greater than the first width; and

a solar control layer having a first portion and a second portion, wherein from a top view, the first portion overlies the first surface, and the second portion overlies the second surface.

Item 9. A transparent composite comprising:

a textured substrate having a first surface, a sidewall, and a second surface that lies at a different elevation as compared to the first surface, wherein the sidewall extends from the first surface toward the second surface; and

a solar control layer having a first portion and a second portion, wherein the first portion overlies the first surface, the second portion overlies the second surface,

wherein the transparent composite:

has a light to solar heat gain coefficient (LTSHGC) greater than 1.05; and

attenuates electromagnetic radiation at a frequency of 1.8 GHz by no greater than 7 dB, or attenuates electromagnetic radiation at a frequency of 4.5 GHz by no greater than 15 dB.

Item 10. A transparent composite comprising:

a textured substrate having a first surface, a sidewall, and a second surface that lies at a different elevation as compared to the first surface, wherein the sidewall extends from the first surface toward the second surface; and

a solar control layer having a first portion and a second portion, wherein the first portion overlies the first surface, the second portion overlies the second surface,

wherein the transparent composite:

has a solar control layer comprising a metal thin film; and

attenuates electromagnetic radiation at a frequency of 1.8 GHz by no greater than 7 dB, or attenuates electromagnetic radiation at a frequency of 4.5 GHz by no greater than 15 dB.

Item 11. A method of forming a transparent composite comprising:

providing a textured substrate having a first surface, a sidewall, and a second surface that lies at a different elevation as compared to the first surface, wherein the sidewall extends from the first surface toward the second surface; and

non-conformally depositing a solar control layer over the textured substrate, wherein step coverage at a point along the sidewall is no greater than 50%.

Item 12. The method of Item 11, wherein the solar control layer has a first portion that overlies the first surface and a second portion that lies over the second surface.

Item 13. The method of Item 11 or 12, wherein non-conformally depositing is performed under vacuum using a physical vapor deposition or chemical vapor deposition technique.

Item 14. The method of any one of Items 11 to 13, wherein non-conformally depositing is performed using sputtering, ion beam deposition, plating, or plasma-enhanced chemical vapor deposition.

Item 15. The method of any one of Items 11 to 14, further comprising removing a part of the solar control layer that lies along the sidewall, wherein after removing the part of the solar control layer, the first and second portions of the solar control layer are disconnected from each other.

Item 16. The method of any one of Items 11 to 15, wherein providing the textured substrate comprises using a mold or a die corresponding to the textured substrate.

Item 17. The method of Item 16, wherein providing the textured substrate comprises extruding a polymer using the die.

Item 18. The method of Item 16, wherein providing the substrate comprises injection molding a polymer using the mold.

Item 19. The method of Item 16, wherein providing the substrate comprises transfer molding a polymer using the mold.

Item 20. The method of Item 16, wherein providing the substrate comprises:

coating an underlying substrate;

embossing the layer with the die; and

curing the layer during embossing.

Item 21. The method of any one of Items 11 to 15, wherein providing the textured substrate comprising:

providing an initial substrate having a first surface that is generally planar; and

removing a portion of the initial substrate to form the textured substrate.

Item 22. The method of any one of Items 11 to 15, wherein providing the textured substrate comprising:

providing an initial substrate having a first surface that is generally planar; and

selectively forming a transparent material over the first surface of the initial substrate to form the textured substrate.

Item 23. The method of Item 22, wherein selectively depositing comprises:

placing a stencil mask over the first surface of the initial substrate; and

depositing the transparent material through an opening in the stencil mask such that a shape of the transparent material on the first surface of the initial substrate corresponds to a shape of the opening.

Item 24. The method of any one of Items 11 to 15, wherein forming the textured substrate comprises:

forming a first layer over a support substrate;

forming a second layer over the first layer;

forming a patterned masking layer over the second layer; and

etching the first layer with an etchant that etches the first layer at a greater etching rate than the second layer.

Item 25. The method of any one of Items 11 to 24, further comprising moving the textured substrate relative to the target so that none of the solar control layer is formed along the second surface, or a thickness of the solar control layer along the second surface is not greater than 70% of a thickness of the solar control layer along the first surface.

Item 26. The method of any one of Items 11 to 25, further comprising tiling the textured substrate relative to the target so that none of the solar control layer is formed along the second surface, or a thickness of the solar control layer along the second surface is not greater than 70% of a thickness of the solar control layer along the first surface.

Item 27. The transparent composite or the method of any one of the preceding Items, wherein the sidewall has a corresponding sidewall angle that is at least 50°, at least 80°, at least 85°, at least 88°, or at least 89°.

Item 28. The transparent composite or the method of any one of the preceding Items, wherein the sidewall has a corresponding sidewall angle that is in a range of 50° to 90°, 80° to 90°, 85° to 90°, 88° to 90°, or 89° to 90°.

Item 29. The transparent composite or the method of any one of Items 1 to 26, wherein the sidewall has a corresponding sidewall angle that is greater than 90°.

Item 30. The transparent composite or the method of Item 29, wherein the sidewall has a corresponding sidewall angle that is in a range of 90.5 to 120°.

Item 31. The transparent composite or the method of any one of Items 1, 2, and 4 to 30, wherein the trench is wider at a point spaced apart from the first surface as compared to at the first surface.

Item 32. The transparent composite or the method of Item 3 or 31, wherein from a cross sectional view, the trench is bowed outward from a centerline of the trench.

Item 33. The transparent composite or the method of Item 3 or 31, wherein from a cross sectional view, the trench is wider at a bottom of the trench as compared to a top of the trench.

Item 34. The transparent composite or the method of any one of the preceding Items, wherein:

the textured substrate defines a trench extending from the first surface; and

the solar control layer having a first portion having a first thickness over the first surface and a second portion having a second thickness over the second surface, wherein as measured in a center of the trench, the second thickness is no greater than 70%, not greater than 50%, not greater than 30%, or not greater than 9% of the first thickness.

Item 35. The transparent composite or the method of any one of the preceding Items, wherein:

the textured substrate defines a trench extending from the first surface; and

the solar control layer having a first portion having a first thickness over the first surface and a second portion having a second thickness over the second surface, wherein as measured in a center of the trench, the second thickness is at least 1% of the first thickness.

Item 36. The transparent composite or the method of any one of the preceding Items, wherein a textured substrate having a first surface and a second surface and defining a trench having a sidewall that lies between the first surface and the second surface, wherein the trench has a width no greater than 5 microns, no greater than 4 microns, no greater than 3 microns, no greater than 2.5 microns, no greater than 1.5 microns, no greater than 0.9 micron, or no greater than 0.5 micron.

Item 37. The transparent composite or the method of any one of the preceding Items, wherein a textured substrate having a first surface and a second surface and defining a trench having a sidewall that lies between the first surface and the second surface, wherein the trench has a width of at least 0.3 micron or at least 0.5 micron.

Item 38. The transparent composite or the method of any one of the preceding Items, wherein a textured substrate having a first surface and a second surface and defining a trench having a sidewall that lies between the first surface and the second surface, wherein the trench has an aspect ratio of depth:width of greater than 1:1, at least 1.5:1, at least 2:1, at least 4:1, or at least 8:1.

Item 39. The transparent composite or the method of any one of the preceding Items, wherein a textured substrate has a first surface and a second surface and defines a trench having a sidewall that lies between the first surface and the second surface, wherein the trench has an aspect ratio of depth:width of no greater than 1000:1.

Item 40. The transparent composite or the method of any one of the preceding Items, wherein the transparent composite has a haze no greater than 5%, no greater than 4%, no greater than 3%, no greater than 2%, or no greater than 1%.

Item 41. The transparent composite or the method of any one of the preceding Items, wherein the transparent composite has a haze of at least 0.01%

Item 42. The transparent composite or the method of any one of the preceding Items, further comprising a trench-fill material having a second refractive index, wherein the textured substrate defines a trench extending from the first surface and has a first refractive index, the trench-fill material is within the trench; and:

the first refractive index is within 0.03 of the second refractive index;

the first refractive index is within 0.02 of the second refractive index; or

the first refractive index is within 0.01 of the second refractive index.

Item 43. The transparent composite or the method of any one of the preceding Items, wherein the solar control layer includes a continuous layer overlying the first surface, wherein the continuous layer has an effective sheet resistance of at least 100 ohms/square, at least 200 ohms/square, at least 400 ohms/square, at least 700 ohms/square, at least 1000 ohms/square, or at least 2000 ohms/square.

Item 44. The transparent composite or the method of any one of the preceding Items, wherein the solar control layer includes a continuous layer overlying the first surface, wherein the continuous layer has an effective sheet resistance no greater than 1 Mohms/square.

Item 45. The transparent composite or the method of any one of the preceding Items, wherein the transparent composite has a light to solar heat gain coefficient (LTSHGC) greater than 1.05, greater than 1.3, greater than 1.4, greater than 1.5, or greater than 1.6.

Item 46. The transparent composite or the method of any one of the preceding Items, wherein the transparent composite has a light to solar heat gain coefficient (LTSHGC) no greater than 2.3.

Item 47. The transparent composite or the method of any one of the preceding Items, wherein the transparent composite attenuates electromagnetic radiation at a frequency of 1.8 GHz by no greater than 7 dB, no greater than 5 dB, no greater than 3 dB, or no greater than 1 dB, or attenuates electromagnetic radiation at a frequency of 4.5 GHz by no greater than 10 dB, no greater than 9 dB, no greater than 8 dB, or no greater than 7 dB.

Item 48. The transparent composite or the method of any one of the preceding Items, wherein the transparent composite attenuates electromagnetic radiation at a frequency of 1.8 GHz by at least 0.01 dB.

Item 49. The transparent composite or the method of any one of the preceding Items, wherein an elevational difference between the first surface of the textured substrate and the second surface of the textured substrate is at least 50 nm, at least 300 nm, or at least 1000 nm.

Item 50. The transparent composite or the method of any one of the preceding Items, wherein an elevational difference between the first surface of the textured substrate and the second surface of the textured substrate is no greater than 10 microns, no greater than 4 microns, no greater than 1 micron.

Item 51. The transparent composite or the method of any one of the preceding Items, wherein an elevational difference between the first surface of the textured substrate and the second surface of the textured substrate is in a range of 50 nm to 10 microns, 300 nm to 4 micron.

Item 52. The transparent composite or the method of any one of the preceding Items, wherein the textured substrate has a pitch that is no greater than 9 cm, no greater than 9 mm, no greater than 5 mm, no greater than 4 mm, or no greater than 900 microns.

Item 53. The transparent composite or the method of any one of the preceding Items, wherein the textured substrate has a pitch that is at least 0.11 micron, at least 0.5 micron, at least 1.1 microns, or at least 2 microns.

Item 54. The transparent composite or the method of any one of the preceding Items, wherein the textured substrate has a pitch that is a range of 0.11 micron to 9 cm, 0.5 micron to 9 mm, 1.1 microns to 5 microns, or at least 2 microns to 4 microns.

Item 55. The transparent composite or the method of any one of the preceding Items, wherein the textured substrate defines a trench having a depth that is no greater than 10 microns, no greater than 6 microns, or no greater than 5 microns.

Item 56. The transparent composite or the method of any one of the preceding Items, wherein the textured substrate defines a trench having a depth that is at least at least 0.05 micron, at least 0.3 micron, at least 1 micron, or at least 2 microns.

Item 57. The transparent composite or the method of any one of the preceding Items, wherein the textured substrate defines a trench having a depth that is in a range of 0.3 micron to 10 microns, 1 micron to 6 microns, or 2 microns to 5 microns.

Item 58. The transparent composite or the method of any one of the preceding Items, wherein the textured substrate defines a trench having a width and a depth, wherein the width is measured at a midpoint along the depth, wherein the width is no greater than 90 microns, no greater than 70 microns, no greater than 50 microns, no greater than 30 microns no greater than 9 microns, or no greater than 5 microns.

Item 59. The transparent composite or the method of any one of the preceding Items, wherein the textured substrate defines a trench having a width and a depth, wherein the width is measured at a midpoint along the depth, wherein the width is at least 0.11 micron, at least 1.1 microns, at least 2 microns, at least 3 microns, at least 4 microns, at least 5 microns, or at least 11 microns.

Item 60. The transparent composite or the method of any one of the preceding Items, wherein the textured substrate defines a trench having a width and a depth, wherein the width is measured at a midpoint along the depth, wherein the width is in a range of 0.11 micron to 90 microns, 1.1 microns to 70 microns, 5 microns to 50 microns, or 2 microns to 30 microns, or 3 microns to 9 microns.

Item 61. The transparent composite or the method of any one of the preceding Items, wherein the textured substrate defines a trench having a bottom surface, wherein from a top view, a percentage of an area along the bottom surface of the trench divided by a surface area of the textured substrate is no greater than 50%, no greater than 0.1%, or no greater than 0.01%.

Item 62. The transparent composite or the method of any one of the preceding Items, wherein the textured substrate defines a trench, wherein the second surface is a bottom surface of the trench, wherein from a top view, a percentage of an area along the bottom surface of the trench divided by a surface area of the textured substrate is at least 1×10⁻⁵%, at least 1×10⁴%, or at least 1×10⁻³%.

Item 63. The transparent composite or the method of any one of the preceding Items, wherein the textured substrate defines a trench, wherein the second surface is a bottom surface, wherein from a top view, a percentage of an area along the bottom surface of the trench divided by a surface area of the textured substrate is in a range of 1×10⁻⁵% to 50%, 1×10⁻⁴% to 1%, or 1×10³% to 0.01%.

Item 64. The transparent composite or the method of any one of the preceding Items, wherein the solar control layer has a thickness that is no greater than 80%, no greater than 50%, no greater than 40%, no greater than 30%, no greater than 90%, or no greater than 9% of an elevational difference between the first surface of the textured substrate and the second surface of the textured substrate.

Item 65. The transparent composite or the method of any one of the preceding Items, wherein the solar control layer has a thickness that is at least 0.02%, at least 0.05%, at least 0.2%, at least 0.5%, at least 2%, at least 11%, or at least 20% of an elevational difference between the first surface of the textured substrate and the second surface of the textured substrate.

Item 66. The transparent composite or the method of any one of the preceding Items, wherein the solar control layer has a thickness that is in a range of 0.02% to 80%, 0/05% to 30%, or 0.2% to 9% of an elevational difference between the first surface of the textured substrate and the second surface of the textured substrate.

Item 67. The transparent composite or the method of any one of the preceding Items, wherein the solar control layer has a thickness over the first surface that is no greater than 1500 nm, no greater than 400 nm, no greater than 160 nm, or no greater than 100 nm.

Item 68. The transparent composite or the method of any one of the preceding Items, wherein the solar control layer has a thickness over the first surface that is at least 10 nm, at least 20 nm, at least 40 nm, or at least 200 nm.

Item 69. The transparent composite or the method of any one of the preceding Items, wherein the solar control layer has a thickness over the first surface that is in a range of 10 nm to 1500 nm, 20 nm to 400 nm, 40 nm to 160 nm, or 50 nm to 200 nm.

Item 70. The transparent composite or the method of any one of the preceding Items, wherein:

the first surface is a first major surface of the textured substrate;

the textured substrate has a second major surface opposite the first major surface; and

a thickness of the textured substrate corresponds to a distance between the first and second major surfaces.

Item 71. The transparent composite or the method of Item 70, wherein the thickness of the textured substrate is at least 110 nm, at least 200 nm, at least 500 nm, or at least 1.1 microns.

Item 72. The transparent composite or the method of Item 70 or 71, wherein the thickness of the textured substrate is no greater than 20 microns, no greater than 9 microns, no greater than 7 microns.

Item 73. The transparent composite or the method of any one of Items 69 to 72, wherein the thickness of the textured substrate is in a range of 110 nm to 20 microns, 500 nm to 9 microns, or 1.1 microns to 7 microns.

Item 74. The transparent composite or the method of any one of the preceding Items, further comprising a support substrate, wherein the textured substrate is disposed between the support substrate and the solar control layer.

Item 75. The transparent composite or the method of Item 74, wherein the thickness of the support substrate is at least 11 microns, at least 17 microns, or at least 25 microns.

Item 76. The transparent composite or the method of Item 74 or 75, wherein the thickness of the support substrate is no greater than no greater than 900 microns, no greater than 600 microns, or no greater than 300 microns.

Item 77. The transparent composite or the method of any one of Items 74 to 76, wherein the thickness of the textured substrate is in a range of 11 microns to 900 microns, 17 microns to 600 microns, or 25 microns to 300 microns.

Item 78. The transparent composite or the method of any one of the preceding Items, further comprising a trench-fill material, wherein:

the textured substrate defines a trench having a sidewall that lies between the first surface and the second surface; and

the trench-fill material is within the trench and overlies the second portion of the solar control layer.

Item 79. The transparent composite or the method of Item 78, wherein the trench-fill material overlies the first surface, and a thickness of the trench-fill material layer over the first surface is at least 0.2 micron, at least 0.5 micron, at least 0.8 micron, or at least 1.1 microns.

Item 80. The transparent composite or the method of Item 78 or 79, wherein the trench-fill material overlies the first surface, and a thickness of the trench-fill material layer over the first surface is no greater than 7 microns, no greater than 5 microns, no greater than 4 microns, or no greater than 3 microns.

Item 81. The transparent composite or the method of any one of Items 78 to 80, wherein the trench-fill material overlies the first surface, and a thickness of the trench-fill material layer over the first surface is in a range of 0.2 micron to 7 microns, 0.5 micron to 5 microns, 0.8 micron to 4 microns, or 1.1 microns to 3 microns.

Item 82. The transparent composite or the method of any one of Items 78 to 81, wherein the textured substrate comprises a first material that is different from the trench-fill material.

Item 83. The transparent composite or the method of Item 82, wherein the textured substrate comprises an acrylate, and the trench-fill material comprises an acetate.

Item 84. The transparent composite or the method of Item 82, wherein the textured substrate comprises a glass, and the trench-fill material comprises polyvinyl alcohol.

Item 85. The transparent composite or the method of Item 82, wherein the textured substrate comprises a glass, and the trench-fill material comprises polyvinyl butyral having nanoparticles that help to match more closely a refractive index of the glass as compared to polyvinyl butyral without the nanoparticles.

Item 86. The transparent composite or the method of any one of Items 1 to 16, 21 to 83, and 85, wherein the textured substrate comprises an inorganic material.

Item 87. The transparent composite or the method of any one of Items 86, wherein the textured substrate comprises a glass, a sapphire, a spinel, or an aluminum oxynitride.

Item 88. The transparent composite or the method of any one of the preceding Items, wherein the trench-fill material comprises a laminating adhesive or a pressure sensitive adhesive.

Item 89. The transparent composite or the method of any one of the preceding Items, wherein the trench-fill material comprises a polyester, acrylate, polyvinyl acetate, a polyvinyl butyral, a polyvinyl alcohol, a silicone rubber, or any mixture thereof.

Item 90. The transparent composite or the method of any one of the preceding Items, wherein the trench-fill material comprises nanoparticles.

Item 91. The transparent composite or the method of Item 90, wherein the nanoparticles include silica, TiO₂, indium tin oxide, or SnO₂ doped with Sb.

Item 92. The transparent composite or the method of any one of the preceding Items, wherein the textured substrate comprises a transparent polymer.

Item 93. The transparent composite or the method of any one of the preceding Items, wherein the textured substrate comprises a polyacrylate, a polyester, a polycarbonate, a polysiloxane, a polyether, or a polyvinyl compound.

Item 94. The transparent composite or the method of any one of the preceding Items, wherein the solar control layer comprises a metal, a metal alloy, a metal oxide, or a metal alloy

Item 95. The transparent composite or the method of any one of the preceding Items, wherein the solar control layer comprises one or a plurality of Ag layers and:

(1) one or a plurality of layers of gold, platinum, palladium, copper, aluminum, indium, zinc, or any combination thereof;

(2) one or a plurality of layers of a titanium oxide (for example, TiO₂), an aluminum oxide, BiO₂, PbO, NbO, SnZnO, SnO₂, SiO₂, ZnO, or any combination thereof; or

both (1) and (2).

Item 96. The transparent composite or the method of any one of the preceding Items, further comprising a support substrate underlying the textured substrate.

Item 97. The transparent composite or the method of any one of the preceding Items, further comprising a hardcoat layer, wherein the textured substrate is disposed between the solar control layer and the hardcoat layer.

Item 98. The transparent composite or the method of any one of the preceding Items, further comprising a release layer, wherein the solar control layer is disposed between the textured substrate and the release layer.

Item 99. The transparent composite or the method of any of the preceding Items, wherein the textured substrate comprises mesas and an interconnected trench between the mesas.

Item 100. The transparent composite or the method of any of the preceding Items, wherein the textured substrate comprises spaced apart trenches.

Item 101. The transparent composite or the method of any of the preceding Items, wherein the textured substrate has a checkerboard pattern of mesas and recessions.

Note that not all of the activities described above in the general description or the examples are required, that a portion of a specific activity may not be required, and that one or more further activities may be performed in addition to those described. Still further, the order in which activities are listed is not necessarily the order in which they are performed.

### Examples

The Examples are given by way of illustration only and do not limit the scope of the present invention as defined in the appended claims. The Examples demonstrate that a transparent composite including a solar control layer can be formed with good solar performance without having excessive signal transmission attenuation for high frequency signals.

Example 1 is performed using substrate of clear polyethylene terephthalate (PET) substrate of 50 microns (2 mils). An acrylate resin that is curable with ultraviolet radiation (UV-acrylate resin) was applied on one side of the PET substrate and embossed by using a patterned stamp during UV curing. The patterned stamp included a silicon wafer with a pattern made by photolithography of a photoresist. The patterned UV-acrylate resin embossed on the PET substrate had the pattern of a grid with the following dimensions: a pitch of 3 mm, trench widths of 2.2 microns; and a trench depth of 4 microns.

Subsequently, a solar control layer was sputtered on top of the embossed structure using a pilot batch sputtering tool. The PET substrate was taped to a piece of flat glass prior entering the vacuum deposition chamber. The solar control layer included multiple films having the following compositions and formed in the following sequence: 30 nm of TiO₂/<1 nm of Au/10 nm of Ag/<1 nm of Au/30 nm of TiO₂. The thickness was based on prior calibration of the deposition condition by measuring the thickness of monolayers deposited on glass using a mechanical profilometer.

Example 2 differs from Example 1 only in the trench widths, which are 4 microns instead of 2.2 microns.

Example 3 differs from Example 1 only in that the UV-acrylate resin was not embossed. Thus, Example 3 has no pattern.

Example 4 differs from Example 2 only in the sequence of the composition of the solar control layer. In Example 4, solar control layer included multiple films having the following compositions and formed in the following sequence: <1 nm of Au/10 nm of Ag/<1 nm of Au.

Example 5 differs from Example 3 only in the sequence of the composition of the solar control layer. In Example 5, solar control layer included multiple films having the following compositions and formed in the following sequence: <1 nm of Au/10 nm of Ag/<1 nm of Au.

The sheet resistance was measured using a non-contact sheet resistance using an instrument, such as a Nagy system.

Measurements of the radiofrequency signal transmission were carried out on a specially designed transmission setup as illustrated in FIG. 19. Two horn antennas were mounted opposite to each other in the vertical polarization configuration. A network analyzer was used as signal source and receiver. The network analyzer was connected to a transmitting and receiving antenna operating at 4.5 GHz. With the transmitting antenna, an electromagnetic field is generated which is assumed to be a plane wave at the position of the device under test (DUT). The calibration of such measurement setup is performed with a signal passing through the opening with no sample in it, that is, transmission through air. All the following measurements thus correspond to transmission values through samples with regards to a signal propagating through air (in the limit of the opening of the measurement setup). Table 1 below includes the data collected.

TABLE 1

| | Example | Example | Example | Example | Example |
|---|---|---|---|---|---|
| | 1 | 2 | 3 | 4 | 5 |
| Description | | | | | |
| Pattern-Trench | 2.2 μm | 4 μm | No | 4 μm | No |
| width | | | pattern | | pattern |
| Stack | TiO₂/ | TiO₂/ | TiO₂/ | Au/Ag/ | Au/Ag/ |
| | Au/Ag/ | Au/Ag/ | Au/Ag/ | Au | Au |
| | Au/TiO₂ | Au/TiO₂ | Au/TiO₂ | | |
| Measurements | | | | | |
| Measured non- | 213 | 108 | 10.9 | 81 | 16.7 |
| contact Sheet | | | | | |
| resistance | | | | | |
| ( [symbol] ) | | | | | |
| Measured | −5.8 | −7.4 | −22.4 | −5.5 | −21.4 |
| radiofrequency | | | | | |
| transmission | | | | | |
| attenuation @ | | | | | |
| 4.5 GHz (dB) | | | | | |

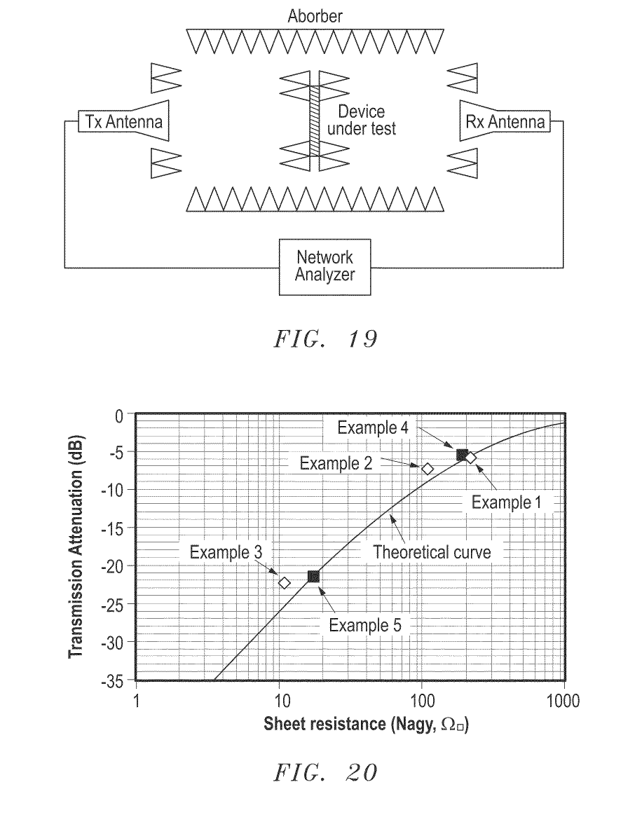

Example 1, 2 and 4 are constructed in accordance with the concepts as described herein, and Examples 3 and 5 are comparative examples. FIG. 20 includes a plot of transmission attenuation as a function of sheet resistance. What is clearly observed is that the addition of the pattern grid according to the above-mentioned dimensions allows for a significant improvement in transmission of the radiofrequencies (>−15 dB attenuation), and thus, the loss in signal strength for high frequency wireless communications is significantly reduced when a window has a solar control layer formed on a patterned layer as opposed to a solar control layer formed on an unpatterned layer.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Certain features, that are for clarity, described herein in the context of separate embodiments, may also be provided in combination in a single embodiment. Conversely, various features that are, for brevity, described in the context of a single embodiment, may also be provided separately or in a subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A transparent composite comprising:
a textured substrate having a first surface and a second surface and defining a trench having a sidewall that lies between the first surface and the second surface;
a solar control layer having a first portion and a second portion, the first portion overlies the first surface, and the second portion overlies the second surface, wherein the second portion is separated from the first portion by the sidewall of the trench; and
a trench-fill material overlying extending into the trench and overlying the second portion of the solar control layer,
wherein the transparent composite has a haze no greater than 5%.

2. The transparent composite of claim 1, wherein:
the textured substrate has a first refractive index; and
the trench-fill material has a second refractive index that is within 0.03 of the first refractive index.

3. The transparent composite of claim 1, wherein the transparent composite attenuates electromagnetic radiation at a frequency of 1.8 GHz by no greater than 7 dB, or attenuates electromagnetic radiation at a frequency of 4.5 GHz by no greater than 15 dB.

4. The transparent composite of claim 3, wherein the transparent composite has a light to solar heat gain coefficient (LTSHGC) greater than 1.05.

5. The transparent composite of claim 1, wherein the trench has a bottom surface, wherein from a top view, a percentage of an area along the bottom surface of the trench divided by a surface area of the textured substrate is no greater than 0.1%.

6. The transparent composite of claim 1, wherein the trench is wider at a point spaced apart from the first surface as compared to at the first surface.

7. The transparent composite of claim 1, wherein the sidewall has a corresponding sidewall angle that is in a range of 80° to 90°.

8. The transparent composite of claim 1, wherein the transparent composite has a light to solar heat gain coefficient (LTSHGC) greater than 1.3.

9. The transparent composite of claim 1, wherein the solar control layer has an effective sheet resistance of at least 100 ohms/square.

10. The transparent composite of claim 1, wherein the trench has a width no greater than 4 microns and a depth less than 4 microns.

11. The transparent composite of claim 1, wherein the textured substrate comprises an acrylate, and the trench-fill material comprises an acetate.

12. A transparent composite comprising:
a textured substrate having a first surface and a second surface and defining a trench having a sidewall that lies between the first surface and the second surface, wherein the textured substrate has a first refractive index;
a solar control layer having a first portion and a second portion, wherein the first portion overlies the first surface, and the second portion overlies the second surface; and
a trench-fill material within the trench and overlying the second portion of the solar control layer, wherein the trench-fill material has a second refractive index,
wherein the first refractive index is within 0.03 of the second refractive index.

13. The transparent composite of claim 12, wherein the transparent composite has a haze no greater than 3%.

14. The transparent composite of claim 12, wherein the trench has a bottom surface, wherein from a top view, a percentage of an area along the bottom surface of the trench divided by a surface area of the textured substrate is no greater than 0.1%.

15. The transparent composite of claim 12, wherein the first refractive index is within 0.01 of the second refractive index.

16. The transparent composite of claim 12, wherein the transparent composite attenuates electromagnetic radiation at a frequency of 1.8 GHz by no greater than 7 dB, or attenuates electromagnetic radiation at a frequency of 4.5 GHz by no greater than 15 dB.

17. The transparent composite of claim 12, wherein the transparent composite has a light to solar heat gain coefficient (LTSHGC) greater than 1.05.

18. The transparent composite of claim 12, wherein the trench is wider at a point spaced apart from the first surface as compared to at the first surface.

19. A method of forming a transparent composite comprising:
providing a textured substrate having a first surface, a sidewall, and a second surface that lies at a different elevation as compared to the first surface, wherein the sidewall extends from the first surface toward the second surface; and
non-conformally depositing a solar control layer over the textured substrate, wherein step coverage at a point along the sidewall is no greater than 50%.

20. The method of claim 19, wherein providing the textured substrate comprises using a mold or a die corresponding to the textured substrate.
